(19) United States
(12) Patent Application Publication
(10) Pub. No.: US 2011/0220388 A1
(43) Pub. Date: Sep. 15, 2011

(54) MULTIPOLAR CABLE AND PRODUCTION METHOD THEREOF

(75) Inventor: Benito Álvaro Sabaris, Merlo (AR)

(73) Assignee: BARROW S.R.L., BUENOS AIRES (AR)

(21) Appl. No.: 12/746,040

(22) PCT Filed: Nov. 28, 2008
(86) PCT No.: PCT/ES08/70223

§ 371 Date: May 27, 2011

(30) Foreign Application Priority Data
Dec. 4, 2007 (AR) P 070105405

(51) Int. Cl. H01B 7/00; B29C 47/02

(52) U.S. Cl. 174/113 R; 264/177.1; 425/113

(57) ABSTRACT

A multipolar cable and method to manufacture it, which presents a plurality of conductors that are separated from one another and physically interconnected by means of a sheathing that is composed of a plurality of plastic insulating materials, whereby there are as many sheathing materials as conductors to be sheathed and whereby each sheathing material sheathes at least the exterior of each conductor.

### BACKGROUND OF THE INVENTION

1. Field of the Invention

The present invention is related to the field of the implements and installations where there is a requirement for the transmission of electrical energy, telephony, data and the like and, more particularly, the invention refers to a multipolar cable, in other words a cable that presents a plurality of conductors that are conductively separated and isolated from each other but connected physically so they can be installed together and separated as required, whereby each of the cable conductors is differentiated by at least one characteristic and preferably a color characteristic.

Although for the purpose of the current description the emphasis lays on the transmission cables for electrical energy for installations of home and/or industrial power supply, it should remain clear that the cables corresponding to the present invention apply to any kind of conduction and transmission as well as any type of environment.

2. Description of the Prior Art

The transmission of electrical energy or telephony, data signals, etc., has imposed the use and development of continuously improving conductors that are differentiated by various characteristics imposed by their type of application but all have one or more internal conductive parts in common and an outer sheathing to protect the user from making contact with the energy that is transported and to preserve the transportation of said energy of electric, electromagnetic or similar fields that interact with each other.

Generally, the multiple conductors of a multipolar cable are tightly coated and held together by a plastic insulating material and in case it is necessary to separate them during usage or installation, the use of cutting instruments is required to facilitate this task. However, this task should be executed with extreme caution because while cutting the small connection between the conductors the cutting tool will often damage the sheathing that covers one of the conductors, with all of the isk that this implies for the installation. Regarding two-conductor cable, probably the most common for home use, this is not a complex task but it can be when multi-conductor cables of a considerable size are used, because of the energy values that are being transported.

With time and in order to facilitate the physical separation of the conductors that make up the multipolar cables, the cables are joined together by the same sheathing materials, as previously known, but using binding membranes that allow for a separation of the conductors by manual cutting or pulling in order to tear the required membranes without compromising the sheathing of each conductor.

Cables with this type of design are amply known, for example in US Patent Application Published No. 2002/0121389 where the same material that sheaths the conductors forms the binding membrane or membranes of the conductors. The same type of conductor is described in French Patent No. 2.025.952 and Belgian Patent No. 512151 of the years 1970 and 1952 respectively. All these documents describe multiple conductors coated by a plastic material that forms the tearable membranes.

This type of cables, with conductors that are held together by membranes that facilitate their separation, have turned out to be very useful. Nonetheless one question has remained unresolved, especially in the case of multi-conductor cables and this question is the identification thereof. For the purpose of the current state of available techniques it would be very useful to have a new multipolar cable with differentially coated conductors, for example with color, without additional manufacturing stages and that would, quite the contrary, allow for a manufacturing process where all conductors are sheathed simultaneously in one simple operation of injecting the different sheathing materials.

### SUMMARY OF THE INVENTION

Therefore it is an object of the present invention to provide a new technology, such as a new cable and the methods to make it, that allows for multipolar cables to be obtained wherein each of their conductors is coated at least externally with different plastic insulating materials.

It is yet another object of the present invention to provide a multipolar cable and method to manufacture it, that presents a plurality of conductors that are separated from one another and physically interconnected by means of a sheathing that is composed of a plurality of plastic insulating materials, whereby there are as many sheathing materials available as there are sheathed conductors and where each sheathing material sheaths at least the exterior of each conductor.

It is yet another other object of the present invention to provide a multipolar cable of the type that has a plurality of conductors that are separated from one another and physically interconnected by means of an insulating material sheathing, wherein said sheathing is comprised of a plurality of plastic insulating materials wherein each of said plastic materials defines at least the outermost sheathing of each one of said conductors, said plastic insulating materials being different from each other in at least one of their technical properties.

Furthermore, it is also an object of the present invention to provide a method to manufacture the multipolar cable of the invention, wherein the method comprises the steps of:

a) providing a plurality of electrical conductors in a manner that each one of the conductors is arranged within a conduit of a plurality of conduits of an extruding die, said conduits being separated but connected to a common central core;

b) injecting within each one of said conduits of the extruding die a plastic insulating material of a plurality of different plastic insulating materials;

c) causing said plastic insulating materials to sheathe each one of the corresponding conductors and to converge into said common central core in a manner that all the conductors are physically connected to each other, and

d) removing said cable from said extruding die.

It is yet another object of the present invention to provide an alternative method to manufacture the multipolar cable of the invention, wherein the method comprises the steps of:

a) providing a plurality of electrical conductors in a manner so that each one of the conductors is arranged within a conduit of a plurality of conduits of an extruding die, said conduits being separated but connected to a common central core;

b) injecting inside one of said conduits of the extruding die, having an inner diameter larger than the diameter of the other conduits of the plurality of conduits, a first plastic insulating material of a plurality of different plastic insulating materials, in a manner so that said first plastic insulating material sheathes said conductor arranged within said first conduit, thus forming a sheathing thickness, said first plastic insulating material also being injected within said other conduits, having a smaller diameter, in a manner so as to sheathe the conductors arranged in said other conduits with a thickness that is lesser than the thickness formed within said first conduit and to physically connect said conductors to one another;

c) moving said conductors sheathed with said first plastic insulating material, into a section of the conduits of the extruding die where said other conduits housing the conductors sheathed with the first insulating material having the lesser thickness, have a diameter larger than the diameter of each conductor sheathed with the first insulating material having the lesser thickness;

d) injecting within each one of said other conduits of the extruding die a plastic insulating material of a plurality of different plastic insulating materials, in a manner that said plastic insulating materials, differing from each other and from said first plastic insulating material, sheathes all the conductors over the sheathing they already contain from said first insulating material having the lesser thickness; and

e) removing said cable from said extruding die.

It is yet another object of the present invention to provide an extruding die assembly to carry out the method of the invention, the apparatus being of the type comprising a conductor feeder for feeding the electrical conductors, at least one hopper containing sheathing material converging into the die assembly, and an output for a sheathed cable that may be allowed to cool for the purpose of reeling, wherein the die assembly comprises:

a plurality of die conduits, said conduits being separated but connected to a common central core, each die conduit being connected to one hopper containing sheathing material, with the die assembly including as many hoppers containing sheathing material as the number of die conduits are provided and each hopper containing a different sheathing material.

Furthermore, it is another object of the present invention to provide an alternative extruding die assembly to carry out the method of the invention, the apparatus being of the type comprising a feeder for feeding the electrical conductors, at least one hopper containing sheathing material converging into the die assembly, and an output for a sheathed cable that may be allowed to cool for the purpose of reeling, wherein the die assembly comprises:

a plurality of die conduits, said conduits being separated but connected to a common central core, said extruding die having at least one first die section and a second die section, said first die section having one first conduit of said conduits of the extruding die, having an inner diameter that is larger than the diameter of the other conduits of the plurality of conduits, one first hopper containing sheathing material being connected to said first conduit and, through said first conduit, to the other conduits of said plurality of conduits, whereby the sheathing material of said first hopper flows through all of the conduits, said die assembly having a second die section having die conduits in fluid communication with the other conduits of the plurality of conduits located in the first section, said die conduits of the second section having a diameter larger than the diameter of the other conduits of the plurality of conduits in said first die section with said first conduit of the first die section keeping the same diameter as in the second die section.

### BRIEF DESCRIPTION OF THE DRAWINGS

For greater clarity and understanding of the objects of the present invention, it has been illustrated in several figures, where the invention has been represented in some of the preferred embodiments, all by way of illustration, wherein:

FIG. 1 shows a cross section of a multipolar cable according to an embodiment of the invention, with three circular section conductors;

FIG. 2 shows a cross section of a multipolar cable according to another embodiment of the invention, with five circular section conductors;

FIG. 3 shows a cross section of a multipolar cable according to another embodiment of the invention, with three circular section conductors;

FIG. 4 shows a cross section of a multipolar cable according to another embodiment of the invention, with five circular section conductors;

FIG. 5 shows a cross section of a multipolar cable according to an embodiment of the invention, with four square section conductors;

FIG. 6 shows a cross section of a multipolar cable according to another embodiment of the invention, with four square section conductors;

FIG. 7 shows a cross section of a multipolar cable according to an embodiment of the invention, with four conductors having a circular-sector section;

FIG. 8 shows a cross section of a multipolar cable according to another embodiment of the invention, with six conductors having a circular-sector section;

FIG. 9 shows a cross section of a multipolar cable according to another embodiment of the invention, with four conductors having a circular-sector section;

FIG. 10 shows a cross section of a multipolar cable according to another embodiment of the invention, with six conductors having a circular-sector section;

FIG. 11 is a schematic side-elevated view of an assembly that includes an extrusion die in agreement with the invention;

FIG. 12 is a cross section of a die assembly according to a first embodiment of the present invention;

FIG. 13 is a cross section of a first die section of a die assembly according to a second embodiment of the present invention;

FIG. 14 is a cross section of a second die section of a die assembly according to a second embodiment of the present invention;

FIG. 15 shows a cross section of a multipolar cable according to another embodiment of the invention, with four trapezoidal section conductors and a hollow central core, with differentiated sheathings on each conductors and that are connected to the central core, as the case of the cable in FIG. 3, and

FIG. 16 shows a cross section of a multipolar cable according to even another embodiment of the invention, also with four trapezoidal section conductors and a hollow central core but manufactured using the method that applied a first sheathing and then a second outer sheathing, as in the case of the cable of FIG. 1.

### DETAILED DESCRIPTION OF THE INVENTION

In reference to the figures we see that the invention consists of a multipolar cable of the type having a plurality of conductors that are separated from one another and physically interconnected by means of an insulating material sheathing.

In order to facilitate reading the description, each of the embodiments for the cable will be identified with reference numbers that begin with a certain ten and its parts will be identified using the numbers of the ten or tens used for that embodiment.

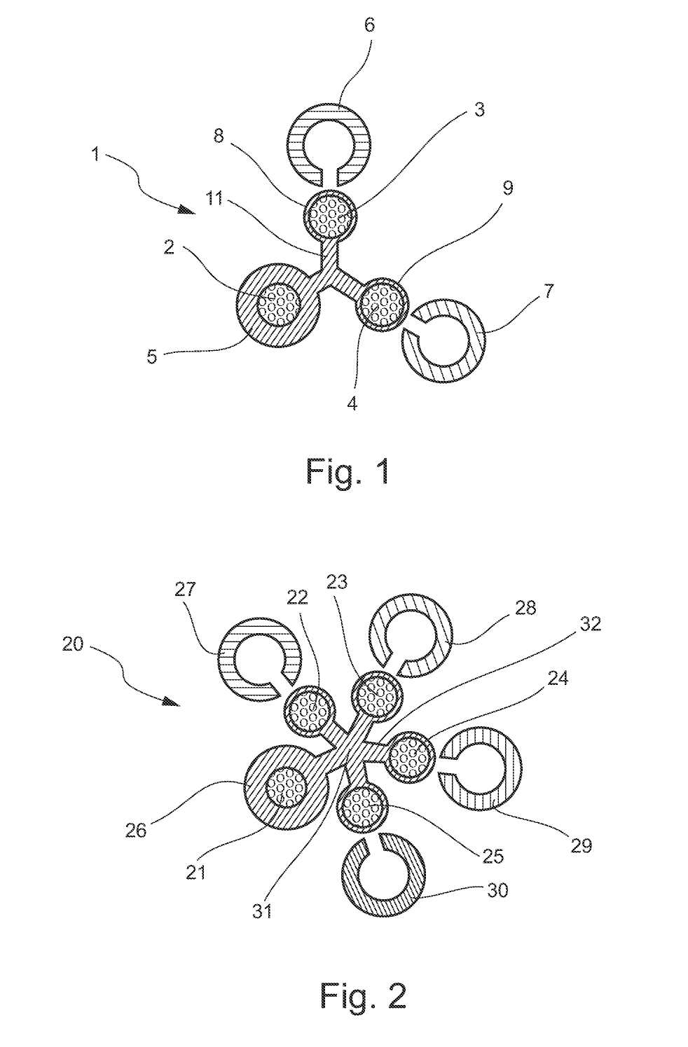

According to the embodiment in FIG. 1, the cable indicated with general reference number 1 contains a plurality of conductors 2, 3 and 4, and a sheathing that is comprised of a plurality of plastic insulating materials 5, 6 and 7.

According to the general concept of the invention, each of said plastic materials defines at least the outermost sheathing of each one of said conductors, said plastic insulating materials being different from each other in at least one of their technical properties. The technical characteristic or specification of each one of the insulating materials can be any adequate one, but preferably it will be color, texture, quality, insulation, dielectric index, etc. This general concept is repeated in all of the following embodiments.

In the embodiment of FIG. 1, one of said conductors, conductor 2, is sheathed with a first plastic insulating material of said plastic insulating materials, material 5, forming a first sheathing having an insulating thickness completely covering said first conductor 2, while it also sheats the rest of the conductors 3 and 4 but with an insulating thickness lesser than 8 and 9 respectively. The plastic insulating materials 6 and 7 (separately illustrated for clarity's sake) of said rest of the conductors 3 and 4 will be presented in the form of exterior sheathing around the corresponding conductor 3 and 4 and around said first sheating having a lesser thickness 8 and 9.

The first 5 of the sheathing materials occupies a central sector 10 and forms three tearable or easily cuttable membranes 11 of which just one is indicated for reasons of clarity of the drawing. These membranes form physical interconnections between the sheathed conductors. In other words, said webs are only formed by said first plastic insulating material 5, but as will be seen in other embodiments, they can be formed by other materials.

In FIG. 2 another embodiment of the cable is shown, based on the same concept of the embodiment in FIG. 1 but with 5 conductors. In fact, the cable in FIG. 2, indicated with the general reference number 20, includes five conductors 21 to 25, wherein the first conductor 21 is sheathed with material 26 while the rest of the conductors have external materials 26 to 30 and a central sector 31 is formed with membranes 32 of which just one has been indicated for reasons of clarity of the drawing.

Even when one of the materials, material 5 and 26, sheaths all of the conductors, it should be highlighted that each conductor is externally sheathed with another one of said plastic insulating materials.

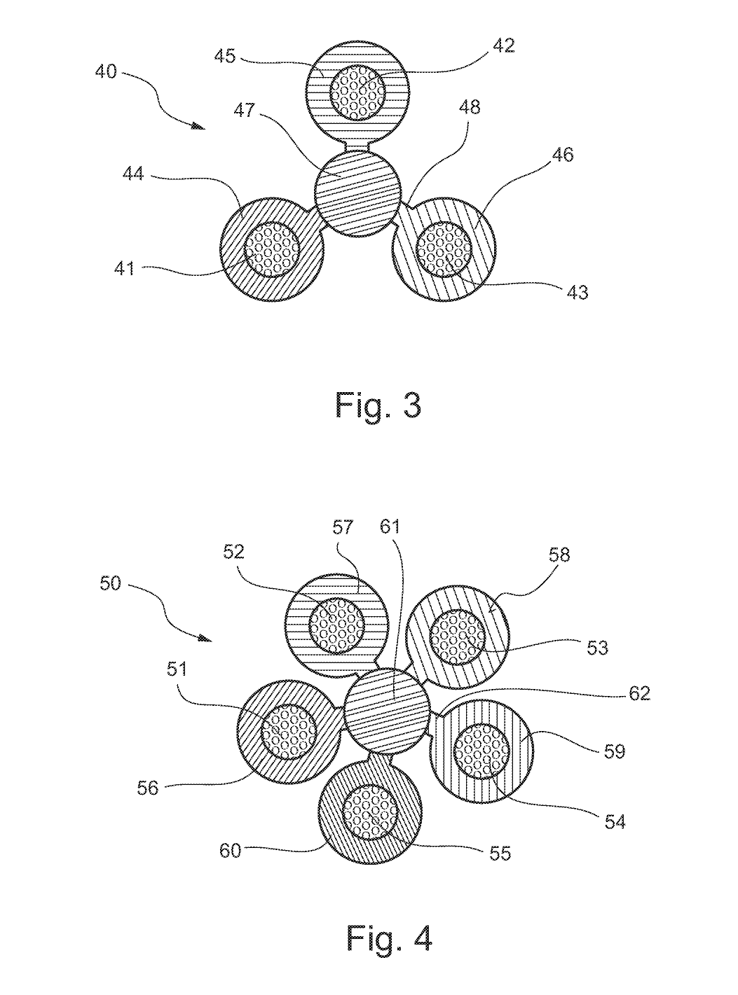

FIG. 3 shows another embodiment of the cable of the invention, indicated with reference number 40, with three circular conductors 41, 42 and 43 and each conductor is sheathed with a different one of said plastic insulating materials, i.e. sheathings 44, 45 and 46 and said plastic insulating materials converge into a central core 47 where the materials may be mixed, causing a mixed color, which is not a problem considering that each conductor is clearly sheathed and identified by the color of its particular sheathing. As in the other embodiments, said conductors sheathed by the plastic insulating materials are interconnected to each other by means of webs formed by at least one of said plastic insulating materials, in this case the three membranes 48, of which only 1 is indicated for reasons of clarity of the drawing. In this embodiment, each one of said webs 48 is formed by one of said plastic insulating materials, said webs extending outwardly from said central core 47.

FIG. 4 illustrates another alternative for the cable, based on the same concept as FIG. 3, which contains the cable 50 with five conductors 51 to 55, independently sheathed with their respective plastic insulating materials 56 to 60, forming a common central core 61 from which the membranes or bridges 61 start out.

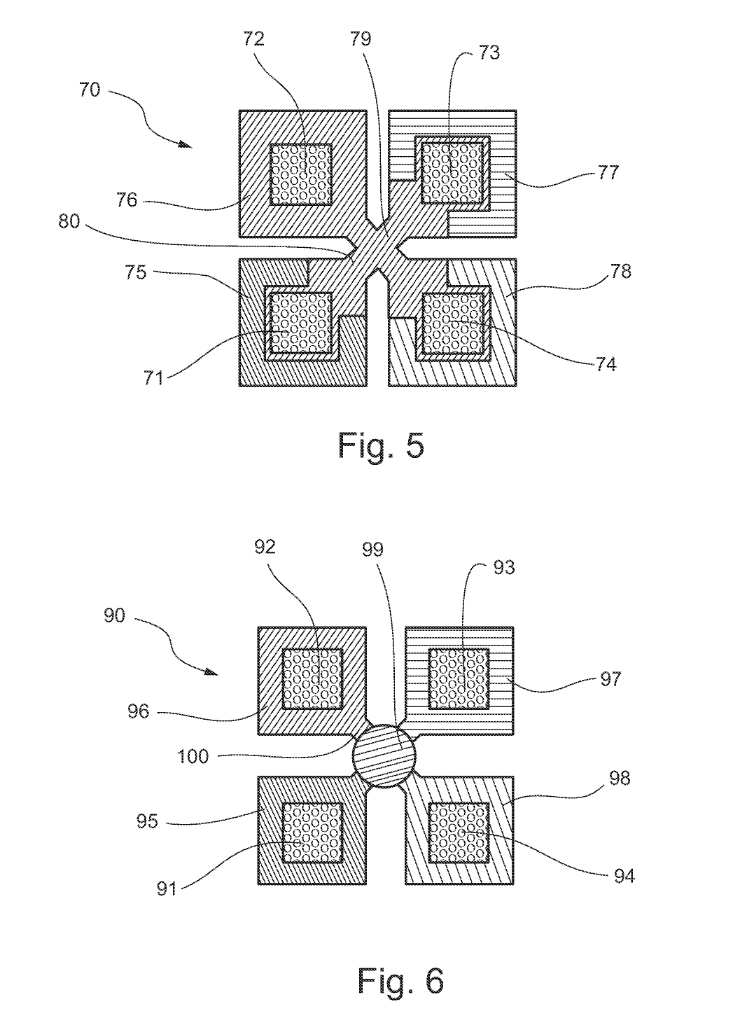

In FIG. 5 another alternative is illustrated based on the concept of the cables shown in FIGS. 1 and 2, wherein a cable 70 contains four square section conductors 71 to 74, where a sheathing material 76, that forms a full thickness sheathing around conductor 72, is thinly extended over the rest of the conductors forming a thin sheathing 81, a central sector 79 and membranes 80. Furthermore, each of the remaining conductors; 71, 73 and 74 are externally sheathed with sheathings 75, 77 and 78 in order to provide them with the desired external characteristic, for example the color.

FIG. 6 illustrates yet another alternative based on the concept shown in FIGS. 3 and 4, wherein a cable 90 contains four square section conductors 91 to 94, where the sheathing material contains four materials 95 to 98 around each one of conductors 91-94 respectively and where the sheathing materials can be easily mixed in the central core 99 from where bridges or membranes 100 start out, that are formed out of each one of the sheathing materials as is the case for the mentioned figures.

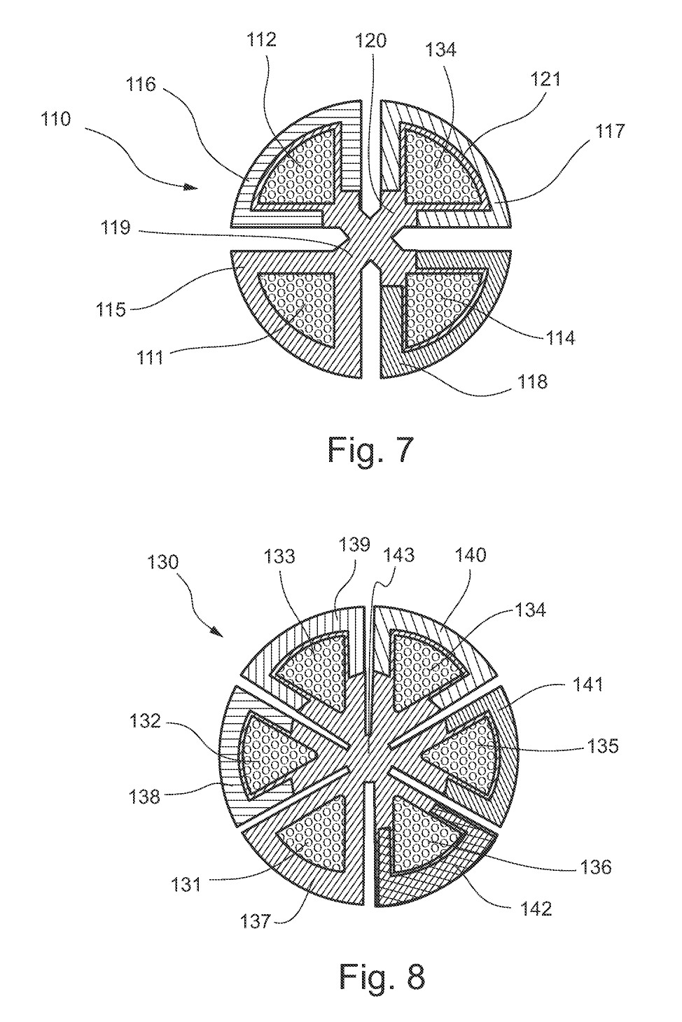

In FIG. 7 another alternative is illustrated based on the concept of the cables shown in FIGS. 1 and 2, wherein a cable 110 contains four circular sector section conductors 111 to 114, where sheathing material 115, that forms a full thickness sheathing around conductor 111, is thinly extended over the rest of the conductors forming a thin sheathing 121, a central sector 119 and membranes 120. Furthermore, each of the remaining conductors; 112, 113 and 114 are externally sheathed with sheathings 116, 117 and 78 in order to provide them with the desired external characteristic, for example the color.

FIG. 8 illustrates another alternative for the cable, based on the same concept as in FIG. 7, which contains a cable 130 with six conductors 131 to 136, independently sheathed with their respective plastic insulating materials 137 to 142. Sheathing material 137 forms a common central core 143 from which the membranes or connections start out, which have not been indicated because, as a result of the circular sector shape of the conductors, they are merged into their vertices.

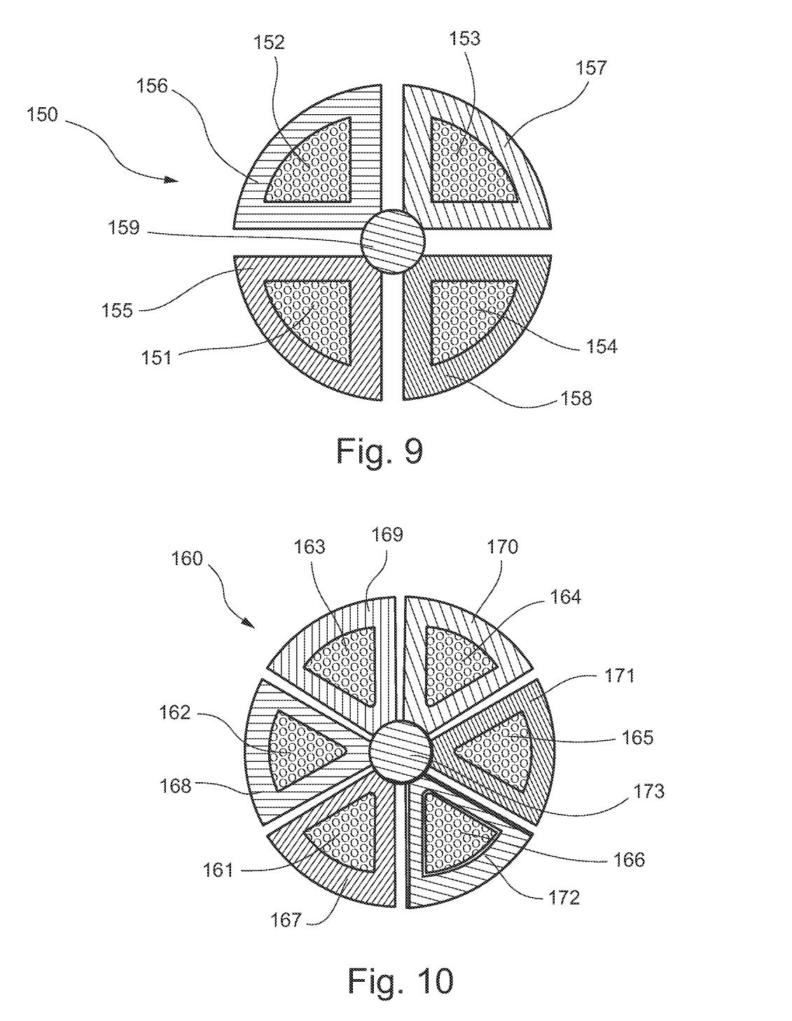

FIG. 9 illustrates yet another alternative based on the concept shown in FIGS. 3 and 4, wherein a cable 150 contains four circular sector section conductors, where the sheathing material contains four materials 155 to 158 around each one of conductors 151-154 respectively and where the sheathing materials can be easily mixed in a central core 159 from where the connections or membranes start out, which have not been indicated because, as a result of the circular sector shape of the conductors, they are joined for their vertices.

Finally, FIG. 10 illustrates another alternative for the cable based on the same concept in FIG. 9, which contains a cable 160 with six conductors 161 to 166, independently sheathed with their respective plastic insulating materials 167 to 172, and where the sheathing materials can be easily mixed in a central core 173 from where the connections and membranes start out that are formed out of each one of the sheathing materials as is the case for the mentioned figures. Nonetheless, the membranes or connections have not been indicated because, as a result of the circular sector shape of the conductors, they are mistaken for their vertices. Of course it is possible to adopt any convenient form of cross section for any of the embodiments, but generally the polygonal, triangular, square or circular are illustrated.

With respect to the manufacturing methods of the embodiments previously described, the cables in FIGS. 3, 4, 6, 9 and 10 are preferably manufactured according to another aspect of the invention, by means of a method that contains the following steps:

a) providing a plurality of electrical conductors in a manner that each one of the conductors is arranged within a conduit of a plurality of conduits of an extruding die, said conduits being separated but connected to a common central core;

b) injecting within each one of said conduits of the extruding die a plastic insulating material of a plurality of different plastic insulating materials;

c) causing said plastic insulating materials to sheathe each one of the corresponding conductors and to converge into said common central core in a manner that all the conductors are physically connected to each other, and

d) removing said cable from said extruding die.

In agreement with another aspect of the invention, the cables in FIGS. 1, 2, 5, 7 and 8 can be manufactured using a method that consists of the following steps:

a) providing a plurality of electrical conductors in a manner that each one of the conductors is arranged within a conduit of a plurality of conduits of an extruding die, said conduits being separated but connected to a common central core;

b) injecting within a first conduit of said conduits of the extruding die, having an inner diameter larger than the diameter of the other conduits of the plurality of conduits, a first plastic insulating material of a plurality of different plastic insulating materials, in a manner that said first plastic insulating material sheathes a conductor arranged within said first conduit to form a sheathing thickness, said first plastic insulating material being also injected within said other conduits, having a smaller diameter, in a manner to sheathe the conductors arranged in said other conduits with a thickness lesser than the thickness formed within said first conduit and to physically connect said conductors to one another;

c) moving said conductors sheathed with said first plastic insulating material into a section of the conduits of the extruding die where said other conduits housing the conductors sheathed with the first insulating material having the lesser thickness have a larger diameter than the diameter of each conductor sheathed with the first insulating material having the lesser thickness;

d) injecting within each one of said other conduits of the extruding die a plastic insulating material of a plurality of different plastic insulating materials, in a manner that said plastic insulating materials, differing from each other and from said first plastic insulating material, sheathes all conductors that are already sheathed with said first insulating material having the lesser thickness; and

e) removing said cable from said extruding die.

In any of the alternative methods previously mentioned, the material or materials will be heated to temperatures between 130° and 170° in an extruding die or similar equipment. The bronze or similar conductors or webs are placed within the head of the machine, whether single-core or multi-core, and these will run along the inside of the heads or die assemblies, as the sheathing material is fed according to the described methods, making the method continuous. The production speed will depend on parameters such as the type of extruding machine, the thickness of the sheathing material, the diameter of the conductors, etc.

The injection dies may be formed from different types of blocks that present the necessary conduits for the formation of the respective sheathings and membranes around the corresponding conductors, with their respective injection nozzles and opening systems to which no specific reference is made as they can be adopted from components that are already known in the art.

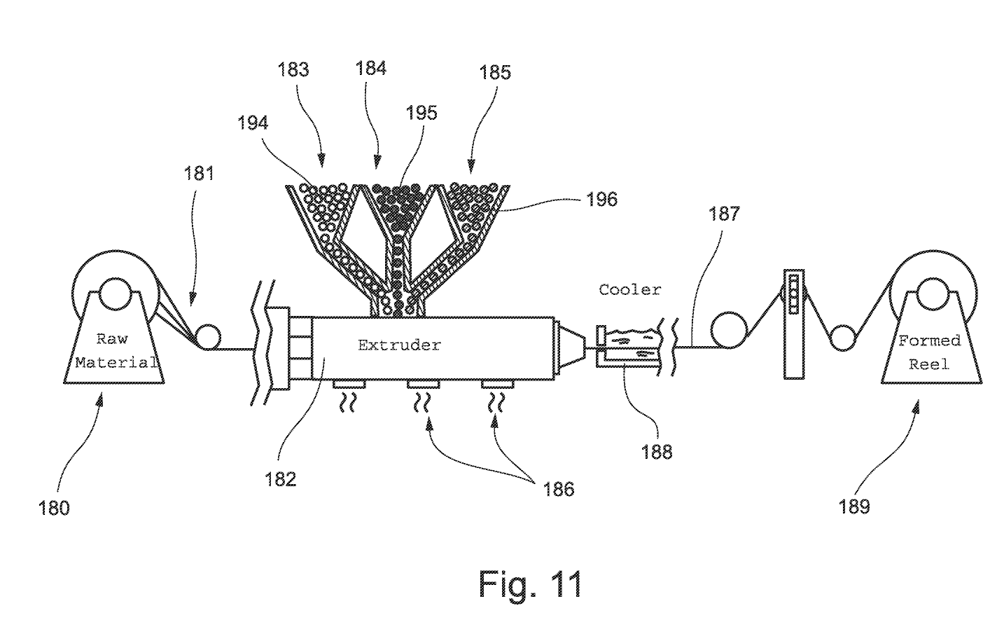

Nevertheless, according to another aspect of the invention, two alternative injection die assemblies are preferably provided that can be used in a machinery to carry out the methods of the invention and to obtain the sheathed cables of the invention. In general, for both alternatives, the equipment that is described in the invention as illustrated in FIG. 11, comprises a feeding reel 180, at the entrance of the equipment, wherein the electrical conductors are housed, which are preferably made of bronze, copper or a similar material and generally identified with reference number 181. Conductors 181 are introduced, also in agreement with the invention, into an extrusion die 182 that contains a heating unit 186 and is fed with the plastic sheathing material through a plurality of feeding hoppers, in this case three hoppers 183, 184 and 185, that are illustrated by means of example, highlighting that this amount can vary according to the desired amount of conductors for the final product. Each hopper will feed the extrusion die a plastic sheathing material, the materials being different from each other in agreement with the technical specification that are to be given to each of the conductors, for example different quality of the PVC, different pigmentation of the PVC, etc. At the exit of the extrusion die the cable of the invention can be seen, identified with reference number 187, which is placed on a cooling tray 188 which may contain a cooling liquid or can consist of a cooling chamber with cooling gasses. Once it has cooled off, cable 187 is rolled onto a storage reel 189. According to the present invention, extrusion die 182 includes at least an extrusion die assembly which will be described below.

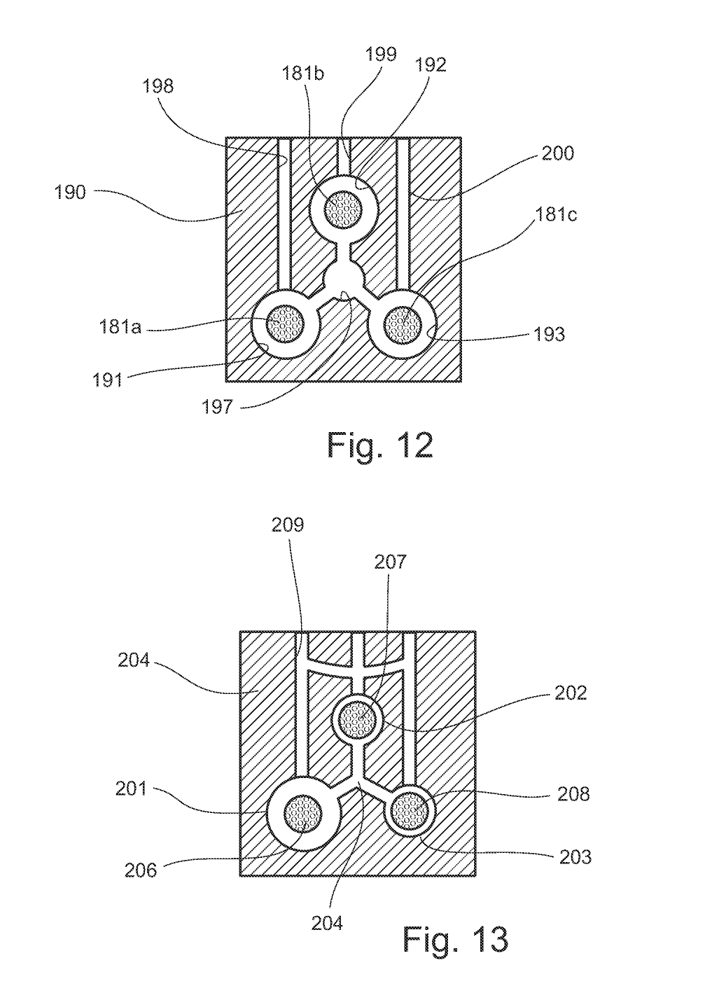

According to a first alternative, an extruding die assembly is provided as shown in the cross section of FIG. 12. A die block 190 with die conduits 191, 192 and 193 has been illustrated schematically, wherein electrical conductors 181 of FIG. 11 are located and circulate and which, in this figure, have been indicated with reference numbers 181a, 181b and 181c. Hoppers 183, 184 and 185 allow for the sheathing material to converge towards the different conduits 191, 192 and 193 in the die assembly. According to the invention, die conduits 191, 192 and 193 are separated from each other but connected to a common central core 197, each die conduit being connected to its respective hopper of sheathing material by means of conduits 198, 199 and 200 which conduct the flowing material under pressure from the extrusion die. This way, materials 194, 195 and 196 sheathe the respective conductors 181a, 181b and 181c inside conduits 191, 192 and 193 and converge towards the central core where they are mixed. As each sheathing material is different, each electrical conductor will be fully sheathed with the desired material and furthermore, in the core where there is no conductor and where the characteristics of the sheathing material need not be the same as around each conductor, the material will combine to form the center of the cable, for example the web or membrane 47, 48 of FIG. 1.

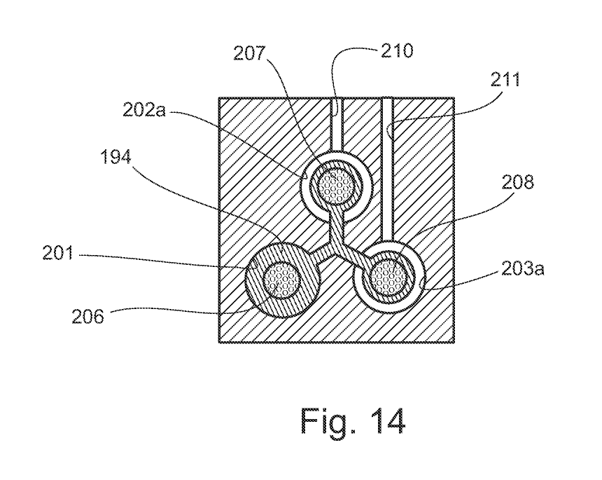

According to a second alternative, an extruding die assembly is provided as illustrated in the cross section of FIGS. 13 and 14. This die assembly also presents a plurality of die conduits 201, 202 and 203, said conduits being separated but connected to a common central core 204. In agreement with the invention, said extruding die presents at least one first die section 204, FIG. 13, and a second die section 205, FIG. 14. Said first die section 204 has one first conduit of said conduits of the extruding die, the one indicated with reference 201, having an inner diameter larger than the diameter of the other conduits of the plurality of conduits 202 and 203. In this first section, a first hopper containing sheathing material, for example hopper 183, will be connected to said first conduit 201 and, through said first conduit, to the other conduits of said plurality of conduits 202 and 203, whereby sheathing material 194 of said first hopper flows through all of the conduits, sheathing the three electrical conductors 206, 207 and 208 by being introduced through feeding conduits 209 which have been illustrated with a particular design but can be given a different one, for example with only one entrance to die block 204, provided that the material in fluid state reaches the three conduits 201, 202 and 203 to fully sheathe the conductors.

In reference to said second die section 205, it presents the same conduits that are used in the first die section 204 but with variations. In fact, conduit 201 is kept the same but the rest of the conduits of the first section undergo a variation of their diameter which now is greater as shown in FIG. 14. Consequently, the conductors that have been sheathed with sheathing material 194 which has a greater thickness around conductor 206 and a lesser thickness around conductors 207 and 208, enter the section where conductors 207 and 208 will encounter a greater diameter in the respective conduits, now indicated as 202a and 203a. Conduits 202a and 203a preferably have the same diameter as conduit 201 and are fed their respective sheathing material 195 and 196 through the corresponding conduits 210 and 211. That is to say, conductors 207 and 208, even when their inner sheathing is equal to that of conductor 206, will present a different outer sheathing so the cable that is the subject of this invention is quickly and efficiently produced.

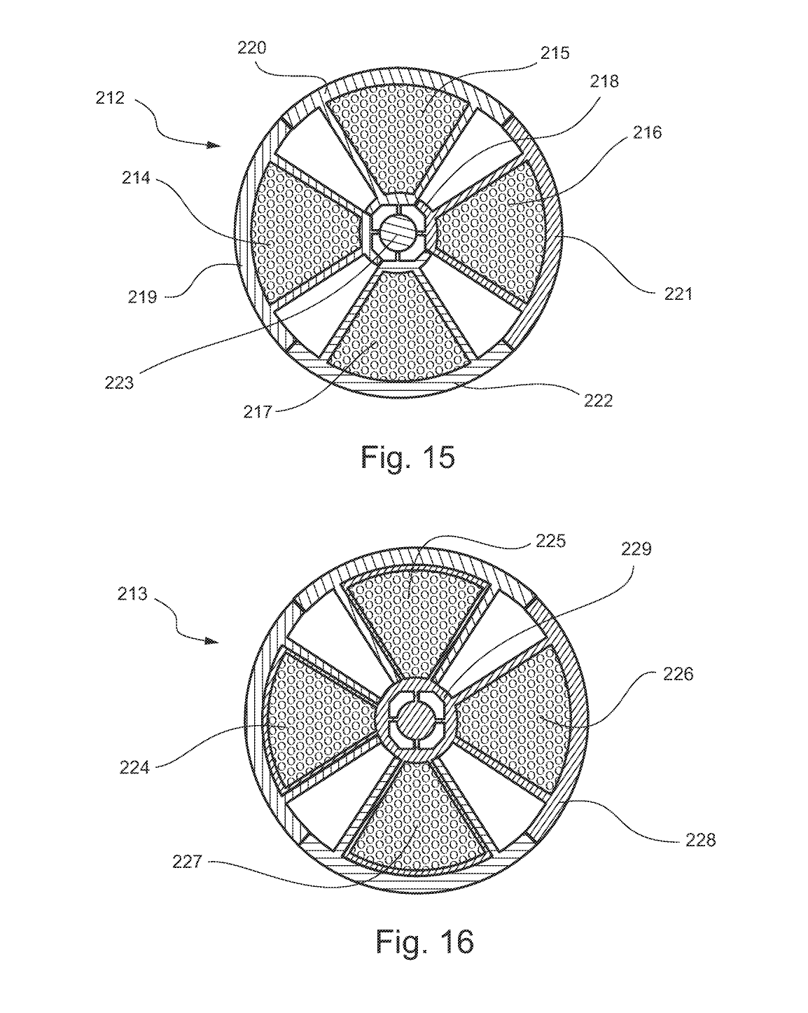

According to even other embodiments of the invention, FIGS. 15 and 16 show cables with four conductors, each of which in turn can be formed by multiple wires, as is known. According to the concepts of the invention, the differentiated sheathings in each conductor are made in agreement with the methods described in the invention but, in contrast with the previously described embodiments, the central core is now hollow. Effectively, cables 212 and 213 present the same characteristics as the remaining embodiments except for the special design of their cores. Cable 212 presents four conductors 214, 215, 216 and 217, each of which is sheathed with a different sheathing material 219, 220, 221 and 222 that are joined in a central core 218, which bears the characteristic of being hollow. This core can be totally hollow or, as illustrated, can have a center core 223 as a result of the mixture of the sheathings involved or may be replaced by another material. Cable 212 is preferably manufactured using the method described above which has also been used to obtain the cables in the FIGS. 3, 4, 6, 9 and 10, i.e. extruding a different material around each conductor and wherein all different materials converge in the central core where they are mixed.

In its turn, cable 213 of FIG. 16 also has four conductors 224, 225, 226 and 227 but its production method is the one described for the manufacturing of the cables in FIGS. 1, 2, 5, 7 and 8, i.e. extruding a first sheathing material 228 which, as can be seen in the figure, comprises each and every one of the conductors, including the central core 229 and extruding afterwards, over said material 228, different sheathings on the exterior of the remaining conductors, i.e. the conductors 224, 225 and 227. In order to obtain a uniform sheathing thickness, as has been seen in the embodiments described above, the material 228 presents a greater thickness around conductor 226 and a lesser thickness around the rest of the conductors in order to permit the adding of the different sheathings on said rest of the conductors with a thickness that is equal to that of conductor 226. However, in all cases, the thicknesses can of course vary and not be maintained, provided that the necessary safety requirements are complied with.

The concept of cable 212 and 213 is to present a hollow central core with the objective to use this central cavity for other purposes. For example, the hollow core can be used as a coolant flow channel for electrical conductions that generate high temperatures. Another example is the use of one or more steel wires that allow for great lengths of cable to be suspended. This would also allow for the use of cables in underground applications.

In order to obtain this hollow core, we can use the dies of the invention described above by modifying the central part of the dies, for example by applying inserts, in a way that the cavity or cavities of the central core 218, 229 are formed.

Finally, it is worth mentioning that the expression different plastic insulating materials, as it is used in this description, should be understood as if all insulating materials that are useful in the industry related to the invention are included, or any new ones, and that the quality of difference will be defined by the difference of at least one of its characteristics or technical specifications, such as quality, insulation, texture, color, etc. For example, the different materials can be the same except for the different pigmentations that are be used, which converts them, for the purposes of this invention, in different materials.

1-16. (canceled)

17. A multipolar cable of the type having a plurality of conductors that are separated from one another and physically interconnected by means of an insulating material sheathing, the cable being wherein sheathing is comprised of a plurality of plastic insulating materials, wherein each of said plastic materials defines at least the outermost sheathing of each one of said conductors, said plastic insulating materials being different from each other in at least one of their technical properties.

18. A cable according to claim 17, wherein at least one technical property is the color of the material.

19. A cable according to claim 17, wherein at least one technical property is the insulating capacity of the material.

20. A cable according to claim 17, wherein one first plastic insulating material of said plastic insulating materials covers one first conductor of said conductors, forming a first sheathing having an insulating thickness completely covering said first conductor, the first sheathing also covering other conductors of said conductors with a thinner insulating thickness, each one of the plastic insulating materials of said other conductors being arranged as a sheathing around its corresponding conductor and around said first sheathing having a lesser thickness, said first sheathing forming a central core.

21. A cable according to claim 17, wherein said plastic insulating materials sheathing the conductors are different for each conductor, and said plastic insulating materials converge into a central core.

22. A cable according to claim 17, wherein said conductors sheathed by the plastic insulating materials are interconnected to each other by means of webs formed by at least one of said plastic insulating materials.

23. A cable according to claim 22, wherein said webs are formed by said first plastic insulating material.

24. A cable according to claim 22, wherein each one of said webs is formed by one of said plastic insulating materials.

25. A cable according to claim 22, wherein each one of said webs is formed by one of said plastic insulating materials, said webs outwardly extending from said central core.

26. A cable according to claim 20, wherein said central core is hollow.

27. A cable according to claim 26, wherein said hollow central core forms a conduit for a cooling fluid.

28. A cable according to claim 26, wherein said hollow central core houses a supporting cable.

29. A cable according to claim 26, wherein said conductors sheathed by the plastic insulating materials have a cross section selected from the group consisting of circular, polygonal, triangular and square sections.

30. A method for manufacturing a multipolar cable comprising the steps of:
a) providing a plurality of electrical conductors in a manner that each one of the conductors is arranged within a conduit of a plurality of conduits of an extruding die, said conduits being separated but connected to a common central core;
b) injecting within each one of said conduits of the extruding die a plastic insulating material of a plurality of different plastic insulating materials;
c) causing said plastic insulating materials to sheathe each one of the conductors to which a material is associated and to converge into said common central core in a manner that all the conductors are physically connected to each other, and
d) removing said cable from said extruding die.

31. The method for manufacturing a multipolar cable according to claim 30, further comprising the steps of:
a) providing a plurality of electrical conductors in a manner that each one of the conductors is arranged within a conduit of a plurality of conduits of an extruding die, said conduits being separated but connected to a common central core;
b) injecting within a first conduit of said conduits of the extruding die, having an inner diameter larger than the diameter of the other conduits of the plurality of conduits, a first plastic insulating material of a plurality of different plastic insulating materials, in a manner that said first plastic insulating material sheathes a conductor arranged within said first conduit to form a sheathing thickness, said first plastic insulating material being also injected within said other conduits, having a smaller diameter, in a manner to sheathe the conductors arranged in said other conduits with a thickness lesser than the thickness formed within said first conduit and to physically connect said conductors to one another;
c) moving said conductors sheathed by said first plastic insulating material into a section of the conduits of the extruding die where said other conduits housing the conductors sheathed by the first insulating material having the lesser thickness have a diameter larger than the diameter of each conductor sheathed by the first insulating material having the lesser thickness;
d) injecting within each one of said other conduits of the extruding die a plastic insulating material of a plurality of different plastic insulating materials, in a manner that said plastic insulating materials, differing from each other and from said first plastic insulating material, sheathes all the conductors already sheathed by said first insulating material having the lesser thickness; and
e) removing said cable from said extruding die.

32. The method according to claim 30, wherein said plastic insulating materials have different colors, in a manner that the exterior of each one of said conductors is sheathed with a color different for each conductor.

33. The method according to claim 30, wherein said conductors sheathed with the plastic insulating materials have a cross section selected from the group consisting of circular, polygonal, triangular and square sections.

34. An extruding die assembly of the type comprising a conductor feeder for feeding the electrical conductors, at least one hopper containing sheathing material converging into the die assembly, and an output for a sheathed cable that may be permitted to cool for reeling, the die assembly comprising:
a plurality of die conduits, said conduits being separated but connected to a common central core, each die conduit being connected to one hopper containing sheathing material, with the die assembly including as many hoppers containing sheathing material as the number of die conduits are provided and each hopper containing a different sheathing material.

35. The extruding die assembly according to claim 34, wherein:
said extruding die having at least one first die section and a second die section, said first die section having one first conduit of said conduits of the extruding die, having an inner diameter larger than the diameter of the other conduits of the plurality of conduits, one first hopper containing sheathing material being connected to said first conduit and, through said first conduit, to the other conduits of said plurality of conduits, whereby the sheathing material of said first hopper flows through all of the conduits, said die assembly having a second die section having die conduits in fluid communication with the other conduits of the plurality of conduits located in the first section, said die conduits of the second section in fluid communication with the other conduits of the plurality of conduits located in the first section having a diameter larger than the diameter of the other conduits of the plurality of conduits in said first die section with said first conduit of the first die section keeping the same diameter as in the second die section.
